(19) United States
(12) Patent Application Publication
(10) Pub. No.: US 2006/0290636 A1
(43) Pub. Date: Dec. 28, 2006

(54) Method and apparatus for driving liquid crystal display device

(75) Inventor: Jin Cheol Hong, Gumi-si (KR)

Correspondence Address: BRINKS HOFER GILSON & LIONE, P.O. BOX 10395, CHICAGO, IL, 60610, US

(73) Assignee: LG PHILIPS LCD CO., LTD.

(21) Appl. No.: 11/205,994

(22) Filed: Aug. 17, 2005

(30) Foreign Application Priority Data
Jun. 27, 2005 (KR) P2005-55449

(51) Int. Cl. G09G 3/36

(52) U.S. Cl. 345/98

(57) ABSTRACT

A method for driving a liquid crystal display is provided. In the method, a first pre-charge voltage and a second pre-charge voltage are generated from an external voltage source separated from a data driving integrated circuit. A data line is pre-charged with the first pre-charge voltage during a first period. The data line is charged to reach a target value of a first data signal during a second period. The data line is pre-charged with the second pre-charge voltage during a third period. The data line is charged to reach a target value of a second data signal during a fourth period. A liquid crystal display device is capable of reducing the heating value of a driver that drives the data line.

This application claims the benefit of Korean Patent Application No. P2005-55449 filed in Korea on Jun. 27, 2005, which is hereby incorporated by reference in its entirety.

### BACKGROUND

1. Technical Field

The invention relates to a liquid crystal display device, and more particularly, to a method and apparatus for driving a liquid crystal display device capable of reducing a heating value of a driver.

2. Related Art

A liquid crystal display device displays a picture by way of controlling a light transmittance of liquid crystal materials having a dielectric anisotropy using an electric field. To this end, the liquid crystal display device includes a liquid crystal panel having a pixel matrix and a drive circuit for driving the liquid crystal panel.

FIG. 1 illustrates a liquid crystal display device 1 that includes a liquid crystal panel 10 having a pixel matrix, a gate driver 12 for driving a gate lines GL of the liquid crystal panel 10, a data driver 14 for driving a data line DL of the liquid crystal panel 10 and a timing controller 16 for controlling the gate driver 12 and the data driver 14.

The liquid crystal panel 10 includes the pixel matrix having pixels formed in an area defined by each intersection of the gate line GL and the data line DL. Each of the pixels has a liquid crystal cell LC controlling a light transmittance depending on a data signal and a thin film transistor TFT for driving the liquid crystal cell LC. The thin film transistor TFT responds to a scan signal of the gate line GL to maintain a data signal charged to the liquid crystal cell LC. The liquid crystal cell LC has a different arrangement of liquid crystal materials in accordance with the data signal to control a light transmittance, thereby realizing gray levels.

The gate driver 12 supplies sequentially a scan signal to the gate line GL in response to a control signal from the timing controller 16. The data driver 14 coverts a digital data from the timing controller 18 into an analog data signal to supply the analog data signal to the data line DL. The timing controller 16 supplies control signals for controlling the gate driver 12 and the data driver 14, and supplies a digital data to the data driver 14.

The liquid crystal display device 1 is intended to have a high resolution and a large scale. A driving frequency and a load amount of the data driver 14 increase and a heating value of the data driver 14 increases in accordance with a large driving voltage required for improving a picture quality. Temperature of the data driver 14 increases to lower reliance, which imposes safety concern such as fire. Accordingly, there is a need of a liquid crystal display device that may lower the temperature of a data driver.

### SUMMARY

By way of introduction only, a method for driving a liquid crystal display is provided. In the method, a first pre-charge voltage and a second pre-charge voltage are generated from an external voltage source separated from a data driving integrated circuit. A data line is pre-charged with the first pre-charge voltage during a first period. The data line is charged to reach a target value of a first data signal during a second period. The data line is pre-charged with the second pre-charge voltage during a third period. The data line is charged to reach a target value of a second data signal during a fourth period.

In other embodiment, a method for driving a liquid crystal display device having a data driving integrated circuit that includes an output buffer is provided. In the method, a first switch is turned off. The first switch is connected between the output buffer and an output terminal of the data driving integrated circuit. The second switch is turned on to pre-charge a supply line of a first pre-charge voltage. The second switch is connected between the supply line of the first pre-charge voltage and the output terminal. A third switch is turned on to pre-charge a supply line of a second pre-charge voltage. The third switch is connected between the supply line of the second pre-charge voltage and the output terminal.

In another embodiment, an apparatus for driving a liquid crystal display device includes an external pre-charge voltage source for generating at least two pre-charge voltages and a data driving integrated circuit. The data driving integrated circuit includes a pre-charge part to select the pre-charge voltage corresponding to the data signal. The pre-charge part is operable to pre-charge the data line with the selected pre-charge voltage.

### BRIEF DESCRIPTION OF THE DRAWINGS

These and other objects of the invention will be apparent from the following detailed description of embodiments with reference to the accompanying drawings, in which:

FIG. 1 is a block diagram illustrating a related art liquid crystal display device;

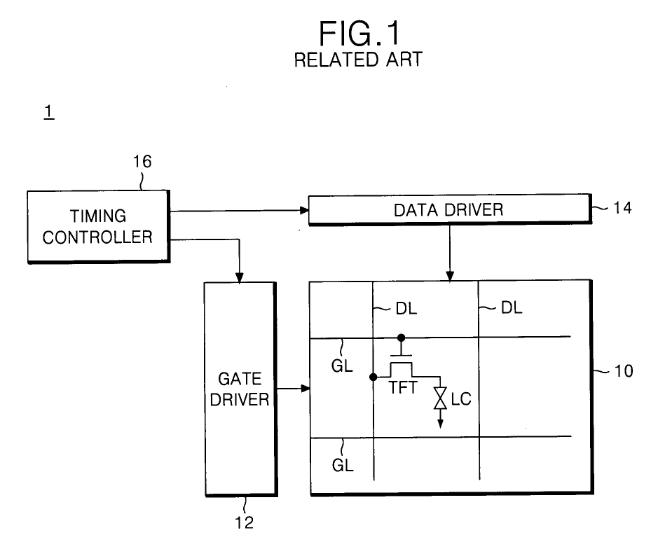

FIG. 2 is a data output waveform diagram of a data driver;

FIG. 3 is a data output waveform diagram in a charge sharing mode;

FIG. 4 is a block diagram illustrating a data driver of a liquid crystal display device according to one embodiment; and

FIG. 5 is a data output waveform diagram of the data driver of FIG. 4.

### DETAILED DESCRIPTION OF THE PREFERRED EMBODIMENT

A data driver may include a data driving integrated circuit (hereinafter, “data D-IC”). The data D-IC may include a heating generation part and a heating emission part, which affect temperature of the data driver. In one embodiment, a liquid crystal display device may lower the temperature of the data D-IC by reducing a heating value in the heating generation part. Energy is converted to heat in accordance with power consumption of the data D-IC and the heating value of the data D-IC is generated. Accordingly, power consumption needs to be reduced to lower the heating value of the data D-IC.

The heating in the data D-IC is mainly generated in the output part of an output buffer. To reduce a heating value of the data D-IC, a heating in the output part of the output buffer should be minimized. To reduce the heating value of the output buffer part, a pre-charge method of a data line may be used. A charge sharing method may be one example of the pre-charge method of the data line.

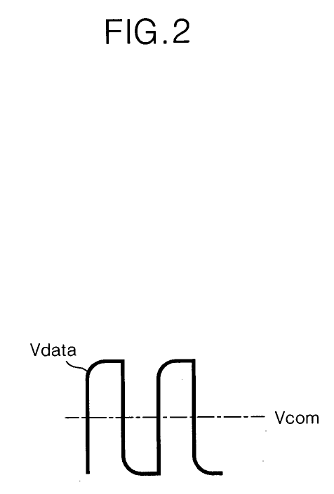

FIG. 2 shows one example of a data output waveform diagram of the data D-IC. A data signal Vdata is output from the data D-IC and is supplied to a data line of a liquid crystal display panel. The data signal Vdata may be a negative or positive voltage with respect to Vcom as shown in FIG. 2. The data signal Vdata may rise to a target value, which ranges between a ground and VDD.

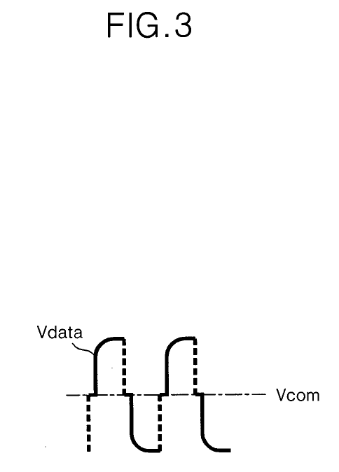

FIG. 3 illustrates the charge sharing method using an electric charge of the liquid crystal display panel. In FIG. 3, the charge sharing method supplies a voltage of about half of the data signal Vdata shown in FIG. 2. The charge sharing method of the data line is capable of reducing charge and discharge currents of an output buffer part of the data D-IC. The charge sharing method shorts the data lines before charging the data signal Vdata. The entire data lines are pre-charged with a half voltage of the data signal Vdata by using the electric charges charged in the data line in the previous period. Accordingly, a dot line part of the data signal Vdata shown in FIG. 3 is driven by the electric charge charged in the data line, and only solid line part is driven with the output buffer part. As a result, it is possible to reduce the values of charge and discharge currents.

Alternatively, or additionally, panel loads may decrease to reduce the charge and discharge currents. This is because the charge and discharge currents increase as the panel loads increase in a large-sized application.

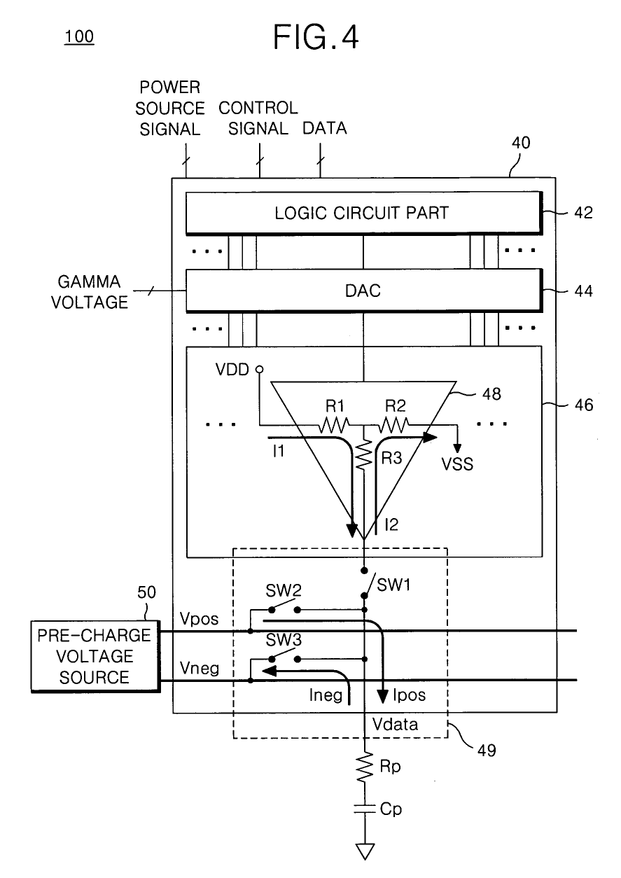

FIG. 4 is a block diagram illustrating a data driver 100 of a liquid crystal display device according to one embodiment. The data driver 100 includes a data D-IC 40 and a pre-charge voltage source 50 for supplying positive and negative pre-charge voltages, Vpos and Vneg. The pre-charge voltage source 50 is external to the data D-IC 40 and separated from the data D-IC 40.

The pre-charge voltage source 50 generates Vpos and Vneg to supply them to the data D-IC 40. The data D-IC 40 converts a digital data signal into an analog data signal by using a power source signal and a control signal, which are an external input. The data driver D-IC 40 supplies the converted data signal to a data line of a liquid crystal display panel. To this end, the data D-IC 40 includes a logic circuit part 42, a digital to analog converter DAC 44, an output buffer part 46 and a pre-charge part 49, which are sequentially connected between an input terminal and an output terminal thereof.

The logic circuit part 42 sequentially samples a digital data input to latch and supply the digital data to the DAC 44. The DAC 44 converts the digital data from the logic circuit part 42 into the analog data signal by using a gamma voltage and supplies the converted analog data signal to the output buffer part 46. The output buffer part 46 adjusts the level of the data signal Vdata, which is output to the data line, up to the level of an input voltage signal from the DAC 44 to compensate for any voltage loss. The output buffer part 46 includes a plurality of output buffers 48 that are respectively connected to the data lines via the pre-charge part 49.

An output buffer 48 adjusts the level of the data signal Vdata from a voltage pre-charged through the pre-charge part 49 up to the level of an input voltage signal from the DAC 44 by using a charge current 11 from a high potential voltage VDD line and a discharge current 12 to a low potential voltage VSS. In this case, the charge current 11 passes through an internal resistance R1 of a first output transistor and an internal resistance R3 of a switch transistor, and the discharge current 12 passes through the internal resistance R3 of the switch transistor and an internal resistance R2 of a second output transistor.

The pre-charge part 49 pre-charges positive and negative charge voltages Vpos and Vneg from the external pre-charge voltage source 50 to the data line in accordance with a polarity of the data signal Vdata. The data line is charged with a positive voltage during one period and with a negative voltage during a next period, as illustrated in FIGS. 2 and 3. During the one period, the data line is pre-charged with Vpos and during the next period, the data line is pre-charged with Vneg. To this end, the pre-charge part 49 includes a first switch SW1 connected to an output line of the output buffer 48, a second switch SW2 connected between the positive pre-charge voltage Vpos supply line and the output terminal of the data D-IC 40 and a third switch SW3 connected between the negative pre-charge voltage Vneg supply line and the output terminal of the data D-IC 40. The first to the third switches SW1, SW2, and SW3 are respectively connected to each output terminal of the data D-IC 40.

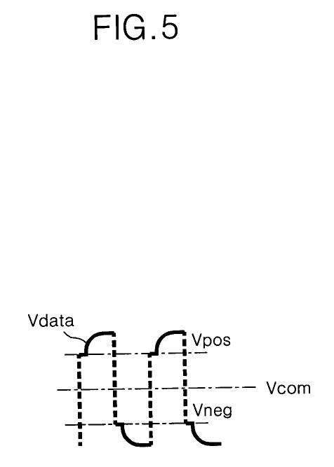

The first switch SW1 is turned off in a pre-charge period. In the pre-charge period, when the data signal Vdata being charged into the data line has a positive polarity as shown in FIG. 5, the second switch SW2 is turned on to thereby pre-charge the positive pre-charge voltage Vpos to the data line with the charge current Ipos. When the data signal Vdata being charged into the data line has a negative polarity as shown in FIG. 5, the second switch SW3 is turned on to thereby pre-charge the negative pre-charge voltage Vneg to the data line with the discharge current Ineg.

The first switch SW1 is turned on in a data charge period. Accordingly, the data signal Vdata reaches from the pre-charged voltage (Vpos and Vneg) up to a target value with the charge and discharge currents I1 and I2 of the output buffer 48. The target value may range between VDD and a ground.

A method for driving the data driver 40 is performed as follows. The external pre-charge voltage source 50 generates Vpos and Vneg. During a first period, the data line is pre-charged with one of Vpos and Vneg. Depending on the polarity of the data voltage, one of Vpos and Vneg may be selected. During a second period, the data line is charged to reach a target value. During a third period, the data line is pre-charged with Vpos or Vneg. During a fourth period, the data line is charged to reach another target value. The pre-charge voltage during the first period and the data signal voltage during the second period have the same polarity. Likewise, the pre-charge voltage during the third period and the data voltage during the fourth period have the same polarity.

The pre-charge voltage may correspond to a gray level voltage which ranges between a peak black level and a peak white level. In one embodiment, the gray level voltage as the pre-charge voltage may range between ½VDD and VDD. For example, the pre-charge voltage may be set at ¾VDD. In other embodiment, the gray level voltage as the pre-charge voltage may range between ½VDD and a ground. Preferably, the pre-charge voltage may be set at ¼VDD. The value of the pre-charge voltage described above is by way of example only and is not limited thereto.

The positive and the negative pre-charge voltages Vpos and Vneg may be set to a middle gray level voltage, e.g., about ¾VDD or ¼VDD. The middle gray level voltage as the pre-charge voltages may reduce the charge and the discharge current I1 and I2 of the output buffer 48. This is because the discharge current I2 becomes greater when the values of the positive and the negative pre-charge voltages Vpos and Vneg are close to a high gray level voltage, and the charge current I1 also becomes greater when the values of the positive and the negative pre-charge voltages Vpos and Vneg are close to a low gray level voltage.

As a result, in the data signal Vdata shown in FIG. 5, the middle gray level voltage corresponding to a dot line part is driven by the pre-charge part 49 and only solid line part is driven with the output buffer part 46. As a result, the values of the charge and discharge currents I1 and I2 may be reduced than those of the charge sharing mode. Power consumption by the internal resistances R1, R2 and R3 of the output buffer part 26 and the charge and discharge current I1 and I2 may be reduced and the heating value of the output buffer 26 also may be reduced. Moreover, the heating value of the data D-IC 40 decreases. Further, because the data signal Vdata more rapidly reaches the target value due to the pre-charge voltages Vpos and Vneg, a charge characteristic may improve. The pre-charge voltage source 50 is located on a printed circuit board PCB separately from the data D-IC 40, so that the heating value of the data D-IC 40 may not increase due to the pre-charge voltages Vpos and Vneg.

As described above, in the method and apparatus for driving data of the liquid crystal display device, the value of current passing through the internal resistance of the output buffer is reduced by using the pre-charge voltage. The pre-charge voltage may have the value corresponding to the middle gray level. Thus, the heating value of the output buffer and moreover, the heating value of the data D-IC may be reduced. Further, the pre-charge voltage source is separated from the data D-IC and the heating generation caused by the pre-charge voltage source may not affect the temperature of the data D-IC.

As a result, even through the liquid crystal display panel has a high resolution and becomes large in size, the temperature of the data D-IC may be lowered to secure a reliance of the data D-IC.

Although the invention has been explained by the embodiments shown in the drawings described above, it should be understood to the ordinary skilled person in the art that the invention is not limited to the embodiments. Various changes and/or modifications are possible without departing from the spirit of the invention. Accordingly, the scope of the invention shall be determined only by the appended claims and their equivalents.

What is claimed is:

1. A method for driving a liquid crystal display device, comprising:
generating a first pre-charge voltage and a second pre-charge voltage from an external voltage source separated from a data driving integrated circuit;
pre-charging a data line with the first pre-charge voltage during a first period;
charging the data line to reach a target value of a first data signal during a second period;
pre-charging the data line with the second pre-charge voltage during a third period; and
charging the data line to reach a target value of a second data signal during a fourth period.

2. The method according to claim 1, wherein pre-charging the data line with the first pre-charge voltage comprises selecting the first pre-charge voltage having the same polarity as that of the data signal.

3. The method according to claim 1, wherein pre-charging the data line with the second pre-charge voltage comprises selecting the second pre-charge voltage having the same polarity as that of the data signal.

4. The method according to claim 1, wherein pre-charging the data line with the first pre-charge voltage comprises pre-charging the data line with a positive pre-charge voltage.

5. The method according to claim 4, wherein pre-charging the data line with the second pre-charge voltage comprises pre-charging the data line with a negative pre-charge voltage.

6. The method according to claim 1, wherein pre-charging the data line with the first pre-charge voltage comprises pre-charging the data line with a gray level voltage wherein the gray level voltage ranges between a peak black level and a peak white level.

7. The method according to claim 6, further comprising determining the gray level voltage to range between ½VDD and VDD.

8. The method according to claim 7, further comprising determining the gray level voltage to be ¾VDD.

9. The method according to claim 1, wherein pre-charging the data line with the second pre-charge voltage comprises pre-charging the data line with a gray level voltage wherein the gray level voltage ranges between a peak black level and a peak white level.

10. The method according to claim 9, further comprising determining the gray level voltage to range between ½VDD and a ground.

11. The method according to claim 10, further comprising determining the gray level voltage to be ¼VDD.

12. A method for driving a liquid crystal display device having a data driving integrated circuit that includes an output buffer, the method comprising:
turning off a first switch connected between the output buffer and an output terminal of the data driving integrated circuit;
turning on a second switch to pre-charge a supply line of a first pre-charge voltage, the second switch connected between the supply line of the first pre-charge voltage and the output terminal; and
turning on a third switch to pre-charge a supply line of a second pre-charge voltage, the third switch connected between the supply line of the second pre-charge voltage and the output terminal.

13. The method according to claim 12, further comprising turning on the first switch to further charge a data line with a data voltage.

14. The method according to claim 12, further comprising turning off the second switch and the third switch while the first switch is turned on.

15. The method according to claim 12, further comprising turning off the third switch while the second switch is turned on.

16. The method according to claim 12, further comprising:
pre-charging the supply line of the first pre-charge voltage with a positive pre-charge voltage; and
pre-charging the supply line of the second pre-charge voltage with a negative pre-charge voltage.

17. An apparatus for driving a liquid crystal display device, comprising:
an external pre-charge voltage source for generating at least two pre-charge voltages; and
a data driving integrated circuit comprising a pre-charge part to select the pre-charge voltage corresponding to the data signal, the pre-charge part operable to pre-charge the data line with the selected pre-charge voltage.

18. The apparatus according to claim 17, wherein the pre-charge voltage source generates a positive pre-charge voltage and a negative pre-charge voltage with respect to a common voltage.

19. The apparatus according to claim 18, wherein the positive and the negative pre-charge voltages are set to a gray level voltage wherein the gray level voltage ranges between a peak black level and a peak white level.

20. The apparatus according to claim 17, wherein the pre-charge part selects the pre-charge voltage in accordance with a polarity of the data signal.

21. The apparatus according to claim 17, wherein the data driving integrated circuit comprises an output buffer and the pre-charge part further comprises a first switch connected between an output line of the output buffer and an output terminal of the data driving integrated circuit.

22. The apparatus according to claim 18, wherein the pre-charge part comprises a second switch connected between a supply line of the positive pre-charge voltage and the output terminal.

23. The apparatus according to claim 22, wherein the pre-charge part comprises a third switch connected between a supply line of the negative pre-charge voltage and the output terminal.

24. The apparatus according to claim 21, wherein the first switch is turned off during a period of pre-charging the data line.

25. The apparatus according to claim 17, wherein the external pre-charge voltage source is separated from the data driving integrated circuit.
